(19) United States
(12) Patent Application Publication
(10) Pub. No.: US 2024/0335064 A1
(43) Pub. Date: Oct. 10, 2024

(54) BOTTLE WARMERS WITH VISUAL INDICATORS

(71) Applicant: MUNCHKIN, INC., Van Nuys, CA (US)

(72) Inventors: Steven Bryan Dunn, Beverly Hills, CA (US); Sung Yun Chan, Pasadena, CA (US); Nicholas Arthur Trumbo, Valencia, CA (US)

(21) Appl. No.: 18/629,863

(22) Filed: Apr. 8, 2024

Related U.S. Application Data
(60) Provisional application No. 63/472,195, filed on Jun. 9, 2023.
(60) Provisional application No. 63/464,496, filed on May 5, 2023.
(60) Provisional application No. 63/458,077, filed on Apr. 7, 2023.

(51) Int. Cl. A47J 36/24

(52) U.S. Cl. CPC A47J 36/2438

(57) ABSTRACT

A bottle warmer is disclosed with various visual indicator levels of fluid volume positioned along a ramp on an interior housing. The visual indicator levels include LEDS which are visible from an interior portion of the interior housing and help indicate the volume level of the fluid. In certain configurations, bottle and liquid sensors are imbedded within the bottle warmer.

### CROSS REFERENCE TO RELATED APPLICATIONS

This application claims priority to U.S. Provisional Patent Application Ser. No. 63/472,195, filed Jun. 9, 2023; and to U.S. Provisional Patent Application Ser. No. 63/464,496, filed May 5, 2023; and to U.S. Provisional Patent Application Ser. No. 63/458,077, filed Apr. 7, 2023; the contents of all of which are hereby incorporated by reference herein in their entirety into this disclosure.

### TECHNICAL FIELD

The subject disclosure relates generally to bottle warmers. More particularly, the present disclosure relates to bottle warmers with interior container visual volume indicators.

### BACKGROUND

A common and universal routine for parents and caretakers that is followed worldwide is to warm up breastmilk or formula before feeding it to an infant. Warming up the milk typically reduces the potential for reflux and allows the infant to receive milk which has been heated up to a temperature that most resembles natural breastmilk.

Various techniques are used to heat up milk or formula. One such technique is to hold the milk bottle containing milk under warm or hot water until it is determined that the milk contained therein has heated to a temperature that is suitable for feeding to an infant. Although this technique is quick and requires no other tools or devices, it is highly inaccurate as it is indeterminable what temperature the milk has reached.

Various conventional bottle warming devices have been designed which warm up a bottle to a designated temperature in a given period of time. The bottle is inserted within a housing with water serving as the heat transfer element between the heating element of the housing and the exterior of the bottle being inserted therein. Depending on the size and shape of the bottle, specific volumes of water have to be poured into the housing to allow the heat transfer to be effective. The specific volume of water is typically measured by an exterior volumetric container, which must be purchased separately from the bottle warming device or is a separable attachment to the bottle warming device. In either case, the exterior volumetric container is an additional element which may be lost or damaged, and must be washed separately from the bottle warming device.

### SUMMARY

The present subject disclosure describes bottle warming devices which have, for example, interior visual volume indicators positioned along a ramp which provide a reference as to how much water is inside the container before a bottle is inserted within. Such features eliminate the need for a separate volumetric container, thereby eliminating the need for an additional element which can be lost or damaged, and need separate cleaning. The present subject disclosure simplifies the bottle heating process by providing indicators inside the housing itself and, thus, further simplifying and speeding up the bottle warming process.

In one exemplary embodiment, the present subject disclosure is a device. The device includes an outer housing; an inner housing; visual indicators positioned on a ramp along the inner housing; wherein the visual indicators are visible from an interior portion of the inner housing; and a sensor positioned on the inner housing, and adapted to turn on one of the visual indicators upon detection of a motion in proximity to the sensor.

In another exemplary embodiment, the present subject disclosure is a device. The device includes an outer housing; an inner housing; a PCB positioned between the outer housing and the inner housing; visual indicators including LED lights and positioned on a ramp along the inner housing; wherein the visual indicators are visible from an interior portion of the inner housing; a first sensor positioned on the inner housing, and adapted to turn on one of the visual indicators upon detection of a motion in proximity to the first sensor; and a second sensor to determine level of fluid to be heated.

In yet another exemplary embodiment, the present subject disclosure is a device. The device includes an outer housing; an inner housing including a cylindrical middle portion and a base; a PCB positioned between the outer housing and the inner housing; visual indicators including LED lights in a series of light up markings, and positioned on a ramp on the cylindrical middle portion of the inner housing; wherein the visual indicators are visible from an interior portion of the inner housing; a first sensor positioned on the inner housing, and adapted to turn on one of the visual indicators upon detection of a motion in proximity to the sensor; and a second sensor to determine level of fluid to be heated.

### BRIEF DESCRIPTION OF THE DRAWINGS

Various exemplary embodiments of this disclosure will be described in detail, wherein like reference numerals refer to identical or similar components or steps. The accompanying drawings, which are incorporated in and constitute a part of this specification, illustrate embodiments of the subject disclosure and technical data supporting those embodiments, and together with the written description, serve to explain certain principles of the subject disclosure. With reference to the following figures, wherein:

FIG. 1 is a front perspective view of a bottle warmer, according to an exemplary embodiment of the present subject disclosure.

FIG. 2 is a front perspective view of a bottle warmer, according to another exemplary embodiment of the present subject disclosure.

FIG. 3 is a front perspective view of a bottle warmer, according to another exemplary embodiment of the present subject disclosure.

FIG. 4 is a front perspective view of a bottle warmer, according to another exemplary embodiment of the present subject disclosure.

FIG. 5 is a front perspective view of a bottle warmer, according to another exemplary embodiment of the present subject disclosure.

FIG. 6 is a front perspective view of a bottle warmer, according to another exemplary embodiment of the present subject disclosure.

FIG. 7 is a front perspective view of a bottle warmer, according to another exemplary embodiment of the present subject disclosure.

FIG. 8 is a front perspective view of a bottle warmer, according to another exemplary embodiment of the present subject disclosure.

FIG. 9 is a front cross sectional cut view of a bottle warmer, according to another exemplary embodiment of the present subject disclosure.

FIG. 10A is a top perspective view of a bottle-first bottle warmer with indicator ramp, according to another exemplary embodiment of the present subject disclosure.

FIG. 10B is a front cross sectional cut view of a bottle-first bottle warmer with indicator ramp, according to another exemplary embodiment of the present subject disclosure.

FIG. 11A is a top perspective view of a bottle-first bottle warmer with indicator ramp, according to another exemplary embodiment of the present subject disclosure.

FIG. 11B is a front cross sectional cut view of a bottle-first bottle warmer with indicator ramp, according to another exemplary embodiment of the present subject disclosure.

FIG. 12A is a top perspective view of a bottle-first bottle warmer with indicator ramp, according to another exemplary embodiment of the present subject disclosure.

FIG. 12B is a front cross sectional cut view of a bottle-first bottle warmer with indicator ramp, according to another exemplary embodiment of the present subject disclosure.

FIG. 13A is a top perspective view of a bottle-first bottle warmer with indicator ramp, according to another exemplary embodiment of the present subject disclosure.

FIG. 13B is a front cross sectional cut view of a bottle-first bottle warmer with indicator ramp, according to another exemplary embodiment of the present subject disclosure.

FIG. 14A is a top perspective view of a bottle-first bottle warmer with indicator ramp, according to another exemplary embodiment of the present subject disclosure.

FIG. 14B is a front cross sectional cut view of a bottle-first bottle warmer with indicator ramp, according to another exemplary embodiment of the present subject disclosure.

FIG. 15A is a top perspective view of a water-first bottle warmer with indicator ramp, according to another exemplary embodiment of the present subject disclosure.

FIG. 15B is a front cross sectional cut view of a water-first bottle warmer with indicator ramp, according to another exemplary embodiment of the present subject disclosure.

FIG. 16A is a top perspective view of a water-first bottle warmer with indicator ramp, according to another exemplary embodiment of the present subject disclosure.

FIG. 16B is a front cross sectional cut view of a water-first bottle warmer with indicator ramp, according to another exemplary embodiment of the present subject disclosure.

FIG. 17A is a top perspective view of a water-first bottle warmer with indicator ramp, according to another exemplary embodiment of the present subject disclosure.

FIG. 17B is a front cross sectional cut view of a water-first bottle warmer with indicator ramp, according to another exemplary embodiment of the present subject disclosure.

FIG. 18A is a top perspective view of a water-first bottle warmer with indicator ramp, according to another exemplary embodiment of the present subject disclosure.

FIG. 18B is a front cross sectional cut view of a water-first bottle warmer with indicator ramp, according to another exemplary embodiment of the present subject disclosure.

FIG. 19A is a front cross sectional cut view of a bottle warmer with sensor that detects the placement of the bottle within the warmer, according to another exemplary embodiment of the present subject disclosure.

FIG. 19B is a front cross sectional cut view of a bottle warmer with sensor that detects the placement the fluid level within a bottle placed therein, according to another exemplary embodiment of the present subject disclosure.

FIG. 20 is a top perspective view of a bottle warmer with sliding touch control, according to another exemplary embodiment of the present subject disclosure.

FIG. 21A is a front view of a bottle warmer with dial control, according to another exemplary embodiment of the present subject disclosure.

FIG. 21B is a top perspective view of a bottle warmer with dial control and bottle, according to another exemplary embodiment of the present subject disclosure.

FIG. 21C is a top perspective view of a bottle warmer showing interior visual indicators, according to another exemplary embodiment of the present subject disclosure.

FIGS. 22A-22E show a water filling, bottle insertion, and heating sequence, according to another exemplary embodiment of the present subject disclosure.

FIGS. 23A-23E show a water filling, bottle insertion, and heating sequence with a point of confusion, according to another exemplary embodiment of the present subject disclosure.

FIGS. 24A-24E show a bottle insertion, water filling, and heating sequence, according to another exemplary embodiment of the present subject disclosure.

FIGS. 25A-25E show a smart sensor controlled water filling, bottle insertion, and heating sequence, according to another exemplary embodiment of the present subject disclosure.

FIGS. 26A-26B show a smart sensor controlled bottle insertion and system inactivation sequence, according to another exemplary embodiment of the present subject disclosure.

FIG. 27 is a top perspective view of a bottle warmer with water level sensor, according to another exemplary embodiment of the present subject disclosure.

FIG. 28 is a front perspective view of a visual indicator light showing an error of a bottle inserted before water filling, according to another exemplary embodiment of the present subject disclosure.

### DETAILED DESCRIPTION

The following detailed description references specific embodiments of the subject disclosure and accompanying figures, including the respective best modes for carrying out each embodiment. It shall be understood that these illustrations are by way of example and not by way of limitation.

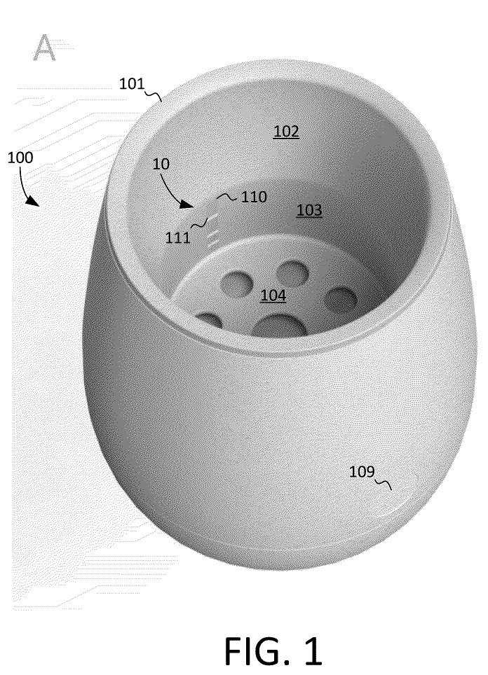

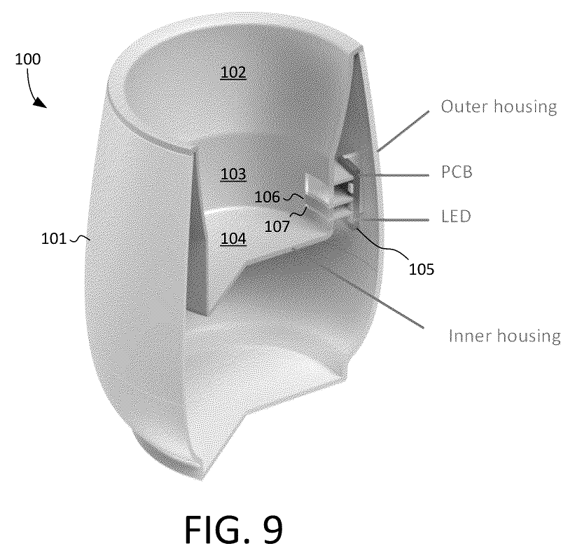

Particular embodiments of a bottle warmer will now be described in greater detail with reference to the figures. FIGS. 1-8 show and describe a bottle warmer 100 in various exemplary embodiments, and FIG. 9 shows and describes a cross sectional perspective view of a bottle warmer 100. All parts between the embodiments are the same and interchangeable, other than those specifically shown and described below.

FIG. 1 shows a bottle warmer 100, according to an exemplary embodiment of the present subject disclosure. As shown in FIG. 1, and in more detail in FIG. 9, the bottle warmer 100 has an outer housing 101 and an inner housing, which includes three components including a top tapered portion 102, a cylindrical middle portion 103, and a base 104, on which a bottle (not shown) may stand. In the embodiment of the bottle warmer 100 shown in FIG. 1, visual (or internal) indicators 10 include a narrow band 110 of vertical light up markings, with specific line indicia 111 indicating specific volumes. The vertical light up markings 110 and line indicia 111 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 111 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 111 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

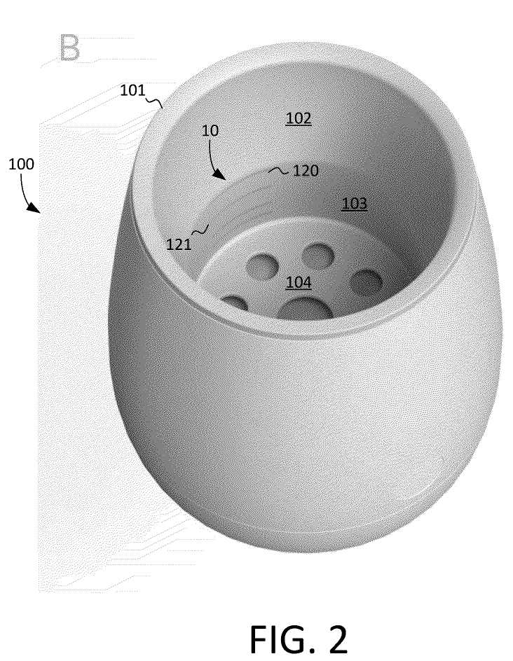

The exemplary embodiments shown in FIGS. 2-8 include different types of visual indicators 10 from those shown in FIG. 1, but their information feedback and process of using the information to heat up the bottle warmer 100 are the same. For each of the examples shown in FIGS. 2-8, the description will be limited to the visual indicators 10, as the function of device 100 is the same as that described above for FIG. 1.

FIG. 2 shows a bottle warmer 100, according to another exemplary embodiment of the present subject disclosure. In the embodiment of the bottle warmer 100 shown in FIG. 2, the interior indicators 10 include a series 120 of wide band horizontal light up markings, with a stack of specific line indicia 121 indicating specific volumes. The series 120 of horizontal light up markings and line indicia 121 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 121 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 121 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

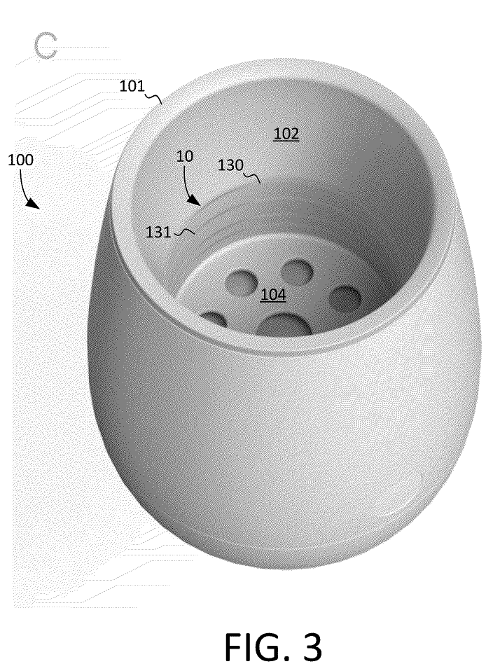

FIG. 3 shows a bottle warmer 100, according to another exemplary embodiment of the present subject disclosure. In the embodiment of the bottle warmer 100 shown in FIG. 3, the interior indicators 10 include a series 130 of continuous band (360 degrees) horizontal light up markings, with a stack of specific line indicia 131 indicating specific volumes. The series 130 of continuous horizontal light up markings and line indicia 131 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 131 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 131 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

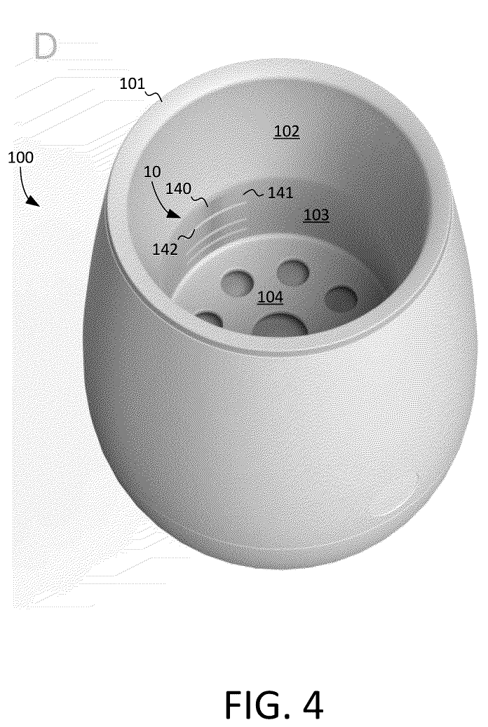

FIG. 4 shows a bottle warmer 100, according to another exemplary embodiment of the present subject disclosure. In the embodiment of the bottle warmer 100 shown in FIG. 4, the interior indicators 10 include a series 140 of vertical light up markings, with a brighter middle portion and a faded edge 141, and a stack of specific line indicia 142 indicating specific volumes. The series 140 of vertical light up markings and line indicia 142 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 142 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 142 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

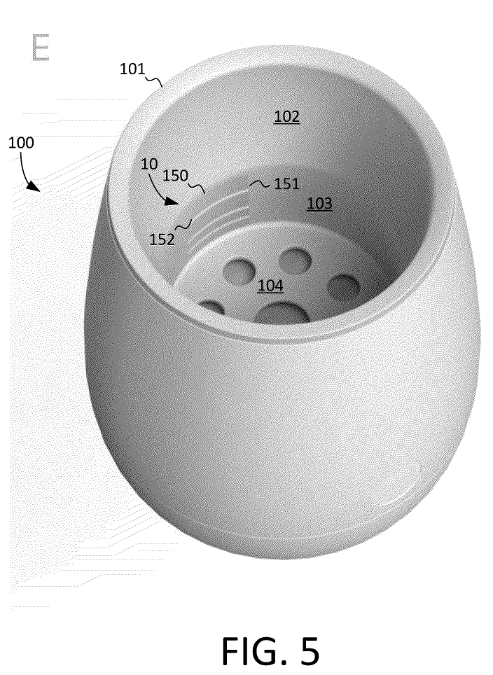

FIG. 5 shows a bottle warmer 100, according to another exemplary embodiment of the present subject disclosure. In the embodiment of the bottle warmer 100 shown in FIG. 5, the interior indicators 10 include a series 150 of vertical light up markings, with a uniform brightness indicator portion with a sharp edge 151, and a stack of specific line indicia 152 indicating specific volumes. The series 150 of vertical light up markings and line indicia 152 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 152 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 152 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

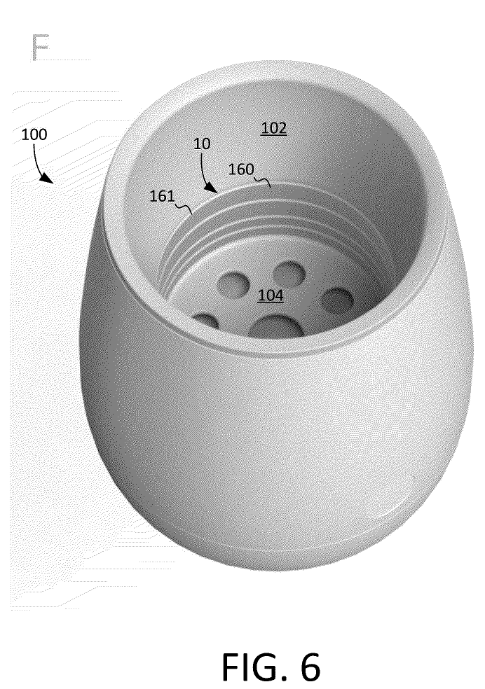

FIG. 6 shows a bottle warmer 100, according to another exemplary embodiment of the present subject disclosure. In the embodiment of the bottle warmer 100 shown in FIG. 6, the interior indicators 10 include a series 160 of same color horizontal nonending uniform brightness indicators, with a stack of specific line indicia 161 indicating specific volumes. The series 160 of horizontal light up markings and line indicia 161 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 161 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 161 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

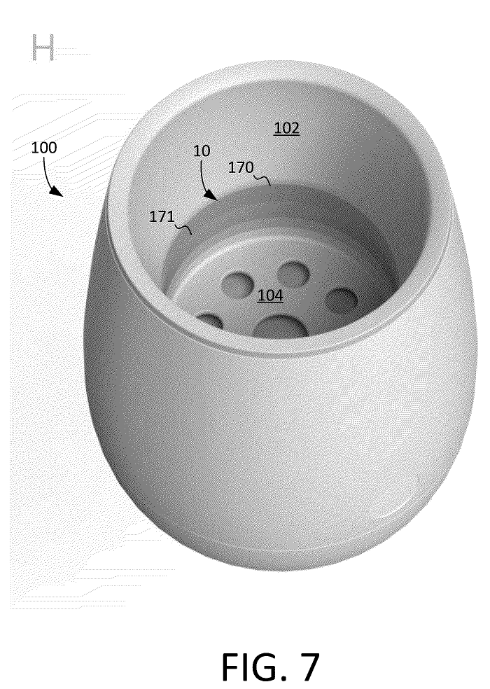

FIG. 7 shows a bottle warmer 100, according to another exemplary embodiment of the present subject disclosure. In the embodiment of the bottle warmer 100 shown in FIG. 7, the interior indicators 10 include a series 170 of varying color horizontal nonending uniform brightness indicators, with a stack of specific line indicia 171 indicating specific volumes. The series 170 of horizontal light up markings and line indicia 171 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 171 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 171 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

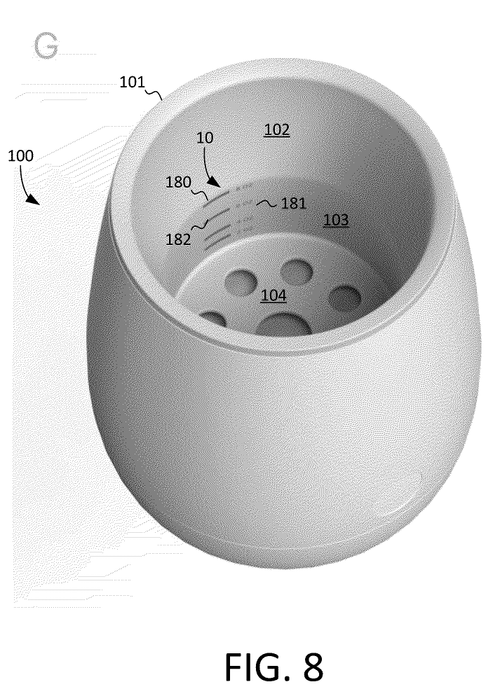

FIG. 8 shows a bottle warmer 100, according to another exemplary embodiment of the present subject disclosure. In the embodiment of the bottle warmer 100 shown in FIG. 8, the interior indicators 10 include a series 180 of vertical light up markings, with an alphanumerical imprint 181 on their edge, and a stack of corresponding specific line indicia 182 indicating specific volumes. The series 180 of vertical light up markings, alphanumeric imprint 181, and line indicia 182 provide a useful visual indicator 10 so that the correct and proper volume of water is poured into the interior housing. For example, for a large width (usually short) bottle, which would take up a substantial portion of the interior volume within the interior housing, a small volume of water is needed, perhaps the first indicia line marker 182 (lowest marker-closest to the base 104) would be needed to provide enough water to effectively heat up the large width bottle. In contrast, if a narrow width (usually tall) bottle is placed into the interior housing, which takes up less volume of the interior volume of the interior housing, then a larger volume of water is needed, perhaps to the last indicia line marker 182 (highest marker-closest to the tapered portion 102). The exact amount of water needed would be dependent on the specific brand, style, and volume of bottle being used, and the volume of fluid contained within that bottle. A manual or electronic guide which provides the user feedback as to which indicia line to use when filling up with water would be included with the bottle heater device 100.

FIG. 9 shows an exemplary embodiment of a heating container 100 according to the present subject disclosure. The general description of the heating container 100 shown in FIG. 9 may be applicable to the specific embodiments shown in FIGS. 1-8, as appreciated by one having ordinary skill in the art. As previously discussed, the bottle warmer 100 has an outer housing 101 and an inner housing, which includes three components including a top tapered portion 102, a cylindrical middle portion 103, and a base 104, on which a bottle (not shown) may stand. The outer housing 101 and inner housing 102/103/104 may be opaque, partially or wholly translucent, or combinations thereof. A PCB (printed control board) 105 contains the necessary electronics to store and transmit information from a control button 109 (See FIG. 1), positioned on an outer housing 101, to the various heating elements (not shown) and temperature sensor (not shown) and visual indicators 106, such as LED lights. The PCB 105 is positioned between the outer housing 101 and inner housing 102/103/104 and acts as control and communication center between the use control button 109 (on/off, temperature select, etc.), heating element, temperature sensor, timer, power source, and visual indicator 106. The visual indicators 106, such as in the form of LED lights, are separated from each other by dividers 107, and relay information to the user through the various embodiments shown in FIGS. 1-8. The dividers 107 between the LED lights 106 are provided to direct the LED source to specific visual indicators 10, such as those shown in FIGS. 1-8.

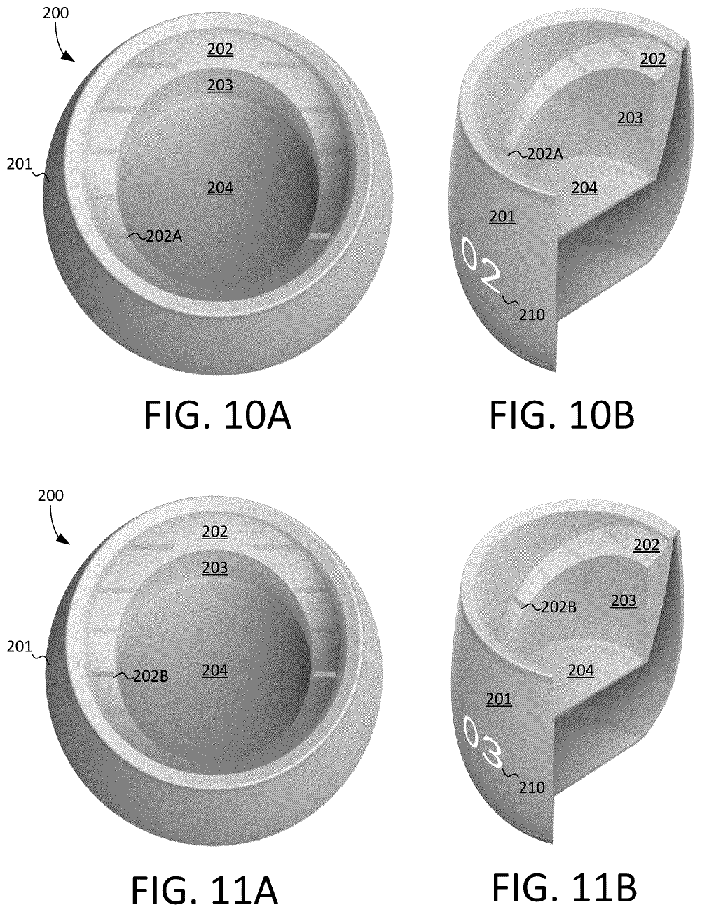

FIGS. 10-14 show a bottle warmer 200 designed to be used in a “bottle-first” technique, according to an exemplary embodiment of the present subject disclosure. In the embodiment of the bottle warmer 200 shown in FIGS. 10-14, the user first places the bottle (not shown) on the base 204 within the interior of the warmer 200, and then determines the level of water to which the interior needs to be filled to effectively heat up the fluid (e.g., milk) contained within the bottle. FIGS. 10A-10B show top perspective and front cross sectional cut views, respectively, of bottle warmer 200 with indicator light 202A illuminated to serve as a guide to the user after placement of the bottle on base 204. Guide light indicator 202A positioned on an inclined ramp 202 on the periphery of middle vertical wall 203 extending from the base 204 to the top of the warmer 200 illuminates according to the set amount desired and indicated on controller/display 210 positioned on the exterior housing 201. The “2” shown in display 210 of FIG. 10B may indicate, for example, ounces, or some other relative unit of measure. For example, if there are two ounces of milk within the bottle that is to be placed within the bottle warmer 200, then the bottle is first placed therein, and the outside controller/display 210 is set to “2” which then illuminates the interior indicator light 202A on the ramp 202 on the side of vertical wall 203, providing the user an easy visual guide to fill the bottle warmer 200 with water up to the point where the top of the water outside of the bottle reaches the illuminated level 202A. The warmer 200 then initiates its warming function either automatically or upon further user interaction.

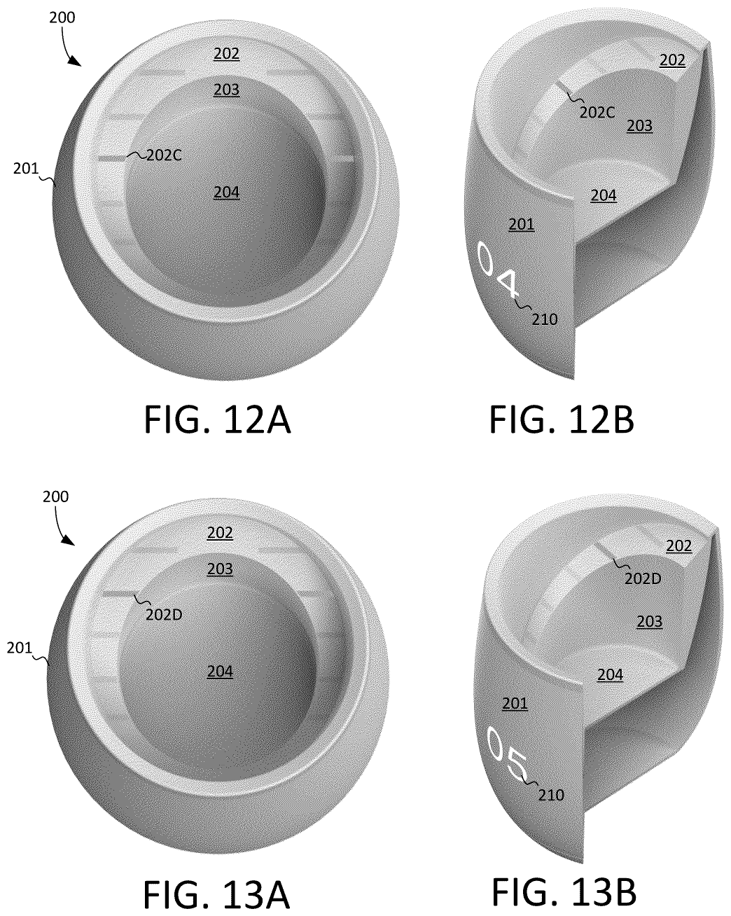

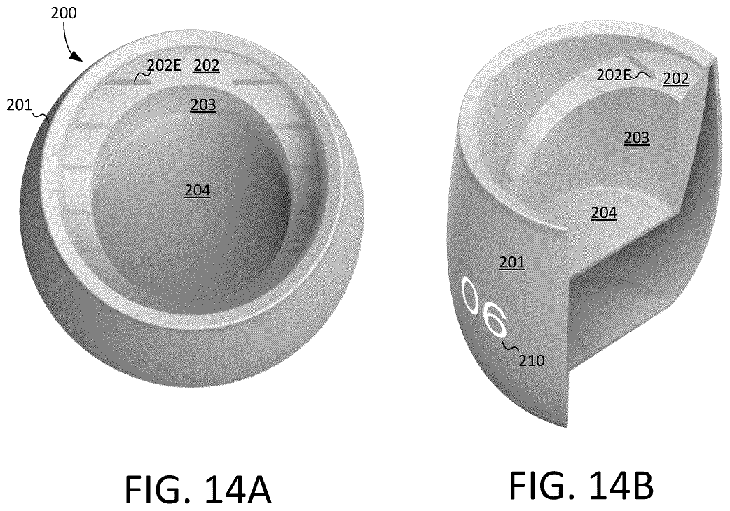

FIGS. 11-14 operate and function in the same manner as described with respect to FIG. 10, but are shown with different guide light indicator levels. The vertical distances between the different guide light indicators shown in FIGS. 10-14 approximate the relative height of the top of the fluid contained within the bottle which is placed within the warmer 200 such that the “2” shown in FIGS. 10A-10B indicate a height level for 2 ounces of milk within a bottle placed therein. Different level settings on the controller/display 210 correspond to different height levels of the guide light indicators. For example, FIGS. 11A-11B show a bottle warmer 200 with guide light indicator 202B illuminated in response to the “03” set in the controller/display 210. FIGS. 12A-12B show a bottle warmer 200 with guide light indicator 202C illuminated in response to the “04” set in the controller/display 210. FIGS. 13A-13B show a bottle warmer 200 with guide light indicator 202D illuminated in response to the “05” set in the controller/display 210. Finally, FIGS. 14A-14B show a bottle warmer 200 with guide light indicator 202E illuminated in response to the “06” set in the controller/display 210. Since there are no further guide light indicators above the 202E level, this level may also be used for filling above the 6 level. Other variations are also possible and within the purview of the present subject disclosure.

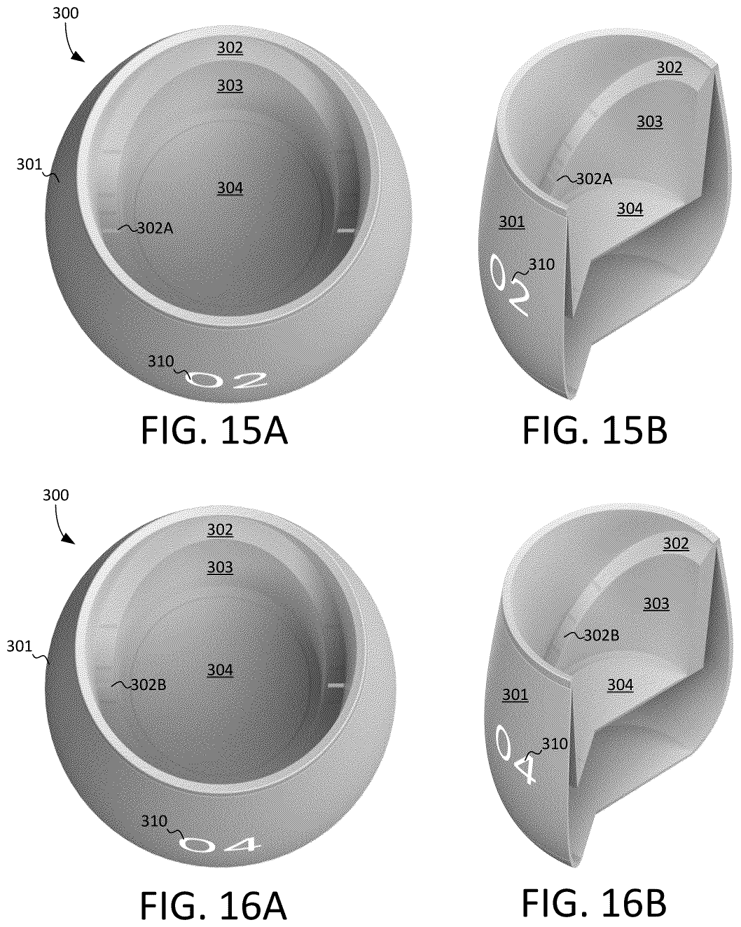

FIGS. 15-18 show a bottle warmer 200 designed to be used with a “water-first” technique, according to an exemplary embodiment of the present subject disclosure. In the embodiment of the bottle warmer 300 shown in FIGS. 15-18, the user first determines the volume of fluid (e.g., milk) contained within a bottle (not shown) which is desired to be heated, sets the determined volume level on the controller/display 310 which results in the illumination of the interior light 302A. The illuminated indicator light 302A then serves as the guide to fill up the warmer 300 to that desired level. FIGS. 15A-15B show top perspective and front cross sectional cut views, respectively, of bottle warmer 300 with indicator light 302A illuminated to serve as a guide to the user for filling with water before placement of the bottle on base 304. Guide light indicator 302A positioned on an inclined ramp 302 on the periphery of middle vertical wall 303 extending from the base 304 to the top of the warmer 300 illuminates according to the set amount desired and indicated on controller/display 310 positioned on the exterior housing 301. The “2” shown in display 310 of FIG. 15B may indicate, for example, ounces, or some other relative unit of measure. For example, if there are two ounces of milk within the bottle that is to be placed within the bottle warmer 300, then the outside controller/display 310 is set to “2” which then illuminates the interior indicator light 302A on the ramp 302 on the side of vertical wall 303, allowing the user easy visual guide to fill the bottle warmer 300 with water up to the point where the top of the water reaches the illuminated level 302A. The user then places the bottle containing the fluid on base 304 within the interior of the warmer 300 which has already been filled with the desired level of fluid. The warmer 300 then initiates its warming function either automatically or upon further user interaction.

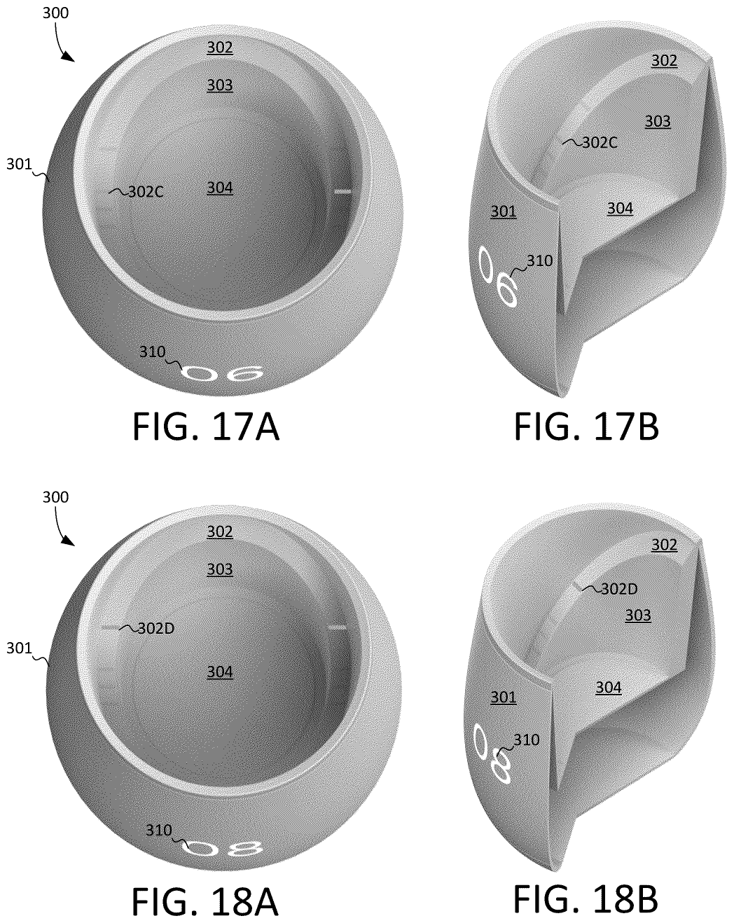

FIGS. 16-18 operate and function in the same manner as described with respect to FIG. 15, but are shown with different guide light indicator levels. The vertical distances between the different guide light indicators shown in FIGS. 16-18 approximate the relative height of the top of the fluid contained within the bottle which is placed within the warmer 300 such that the “2” shown in FIGS. 15A-15B indicate a height level for 2 ounces of milk within a bottle placed therein. Different level settings on the controller/display 310 correspond to different height levels of the guide light indicators. For example, FIGS. 16A-16B show a bottle warmer 300 with guide light indicator 302B illuminated in response to the “04” set in the controller/display 310. FIGS. 17A-17B show a bottle warmer 300 with guide light indicator 302C illuminated in response to the “06” set in the controller/display 310. Finally, FIGS. 18A-18B show a bottle warmer 300 with guide light indicator 302D illuminated in response to the “08” set in the controller/display 310. Since there are no further guide light indicators above the 302D level, this level may also be used for filling above the 8 level. Other variations are also possible and within the purview of the present subject disclosure.

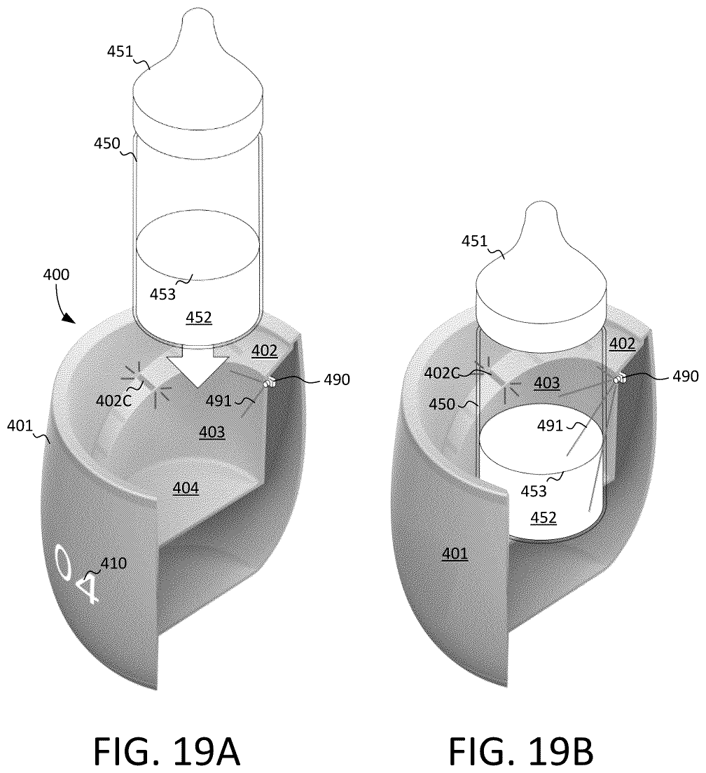

FIGS. 19A-19B show another exemplary embodiment of a bottle warmer 400, having a controller/display 410 positioned on an exterior housing 401, and a measured spiral ramp 402 positioned along an interior vertical wall 403 which extends from a base 404 up to the top portion of the interior of the warmer 400. A standard bottle 450 with a nipple 451 has fluid 452 (e.g., milk) contained therein, up to a top level 453. The bottle 450 is positioned into the interior of the warmer 400 so that it sits upon the base 404. Upon placement of the bottle 450 within the warmer 400, a sensor 490 positioned on an interior portion of the warmer 400, for example on the vertical wall 403, detects the bottle 450 through light 491 and initiates the operation of the warmer 400. As shown in FIG. 19B, the sensor 490 uses light 491 to sense and detect the top level 453 of the fluid 452 positioned in the bottle 450 placed on the base 403, and automatically relays information to the user through illuminated level 402C as to the ideal level of water to be poured therein (outside of the bottle 450). This automated sensor detection and recommendation facilitates the process of determining the level of water to be poured into the warmer 400 outside of the bottle 450 to heat up the fluid 452 within the bottle 450. Display 410 may also provide visual information as to the recommended level as determined by the sensor 490. A user may use the controlled/display 410 to override the recommended level 402C as determined by the sensor 490 in cases where more or less water is desired.

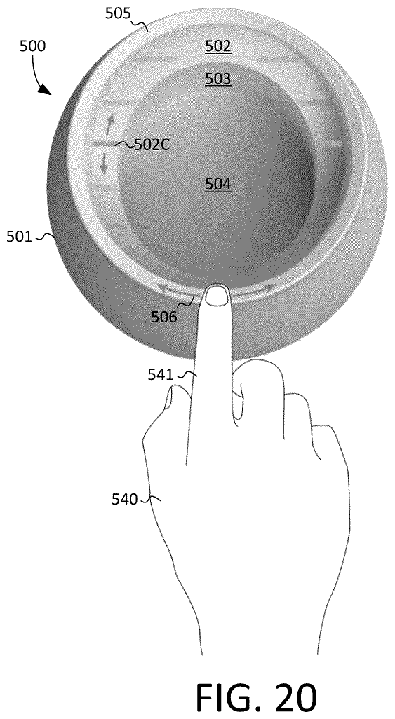

FIG. 20 shows another exemplary embodiment of a bottle warmer 500, having a housing 501 and measured spiral ramp 502 positioned along an interior vertical wall 503 which extends from a base 504 up to a top rim 505 of the warmer 400. Bottle warmer 500 has a sliding finger control feature 506 positioned on the top rim 505 which allows the finger 541 of a hand 540 of a user to set the desired illuminated level 502C on the ramp 502. The position of the sliding finger control 506 on the top rim 505 allows the user to be able to have a singular visual field view of the warmer 500 from the top side and be able to see the illuminated level 502C, etc. while sliding the finger 506 accordingly. This allows for easier visual-tactile control of the desired water level. Such feature may be incorporated into any of the embodiments described throughout this subject disclosure.

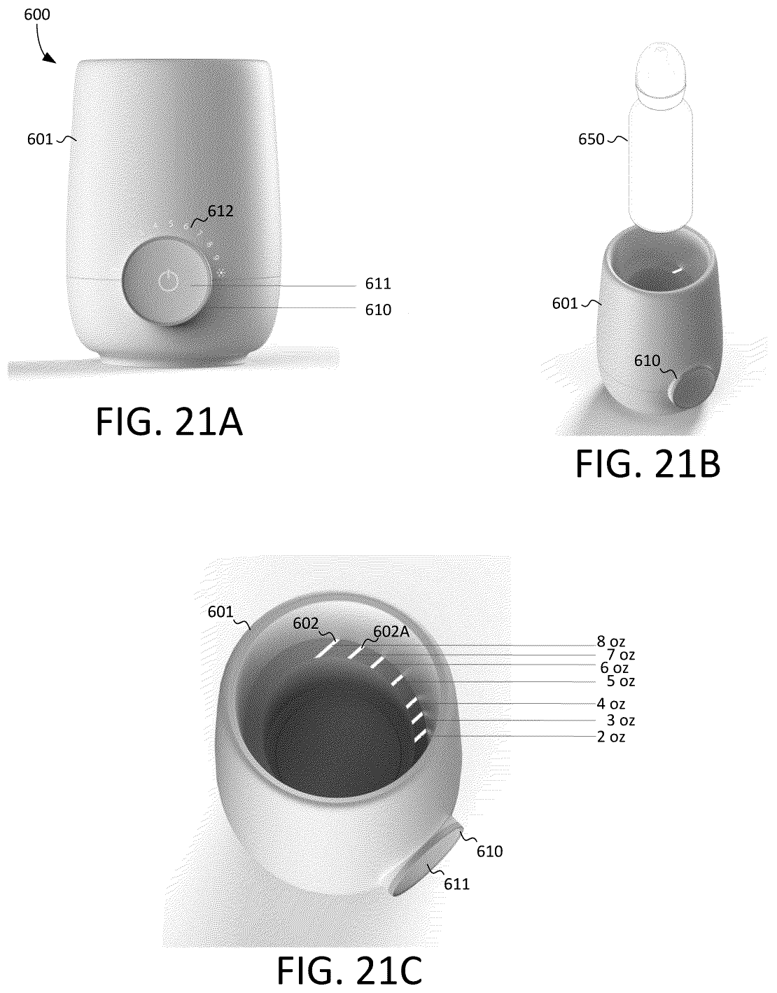

FIGS. 21A-21C show another exemplary embodiment of the bottle warmer 600 having a housing 601 and measured spiral ramp 602 with various visual indicators 602A representing different volumetric levels (shown as 2 oz, 3 oz, 4 oz, 5 oz, 6 oz, 7 oz, and 8 oz). A turnable controller 610 having a push button visual display 611 is positioned on an exterior surface of the housing 601. The controller 610 is shown as a circular dial with graded numeric indicators 612. The numeric indicators 612 could correspond to the various visual indicators 602A indicating volume measurements on the spiral ramp 602. The numeric indicators 612 can also allow various control modes for the bottle warmer 600. The display 611 may also be touch sensitive such that it allows the bottle warmer 600 to be turned on or off, or toggled into various standby or timer modes. A bottle 650 is placeable within the interior of the housing 601 to initiate the bottle warming sequence.

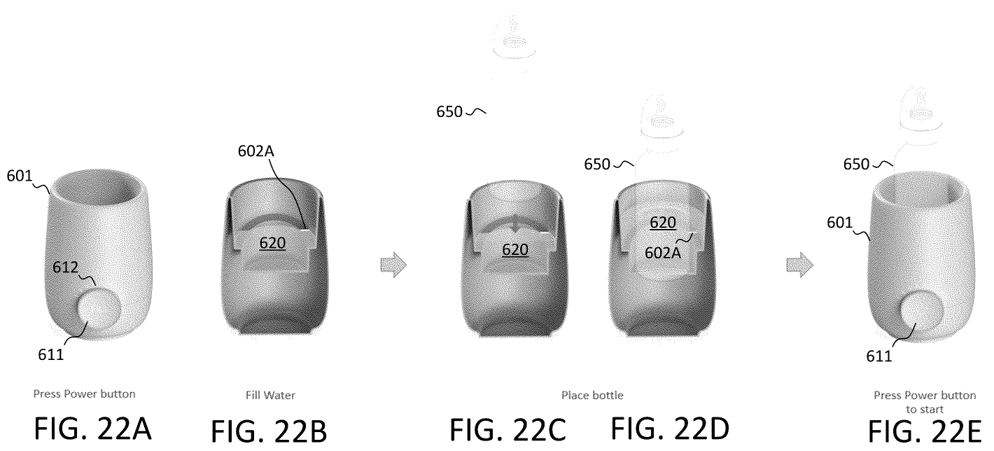

FIGS. 22A-22E show an exemplary sequence of user experience with the bottle warmer 600. FIG. 22A shows the initial step of selecting a particular volume or mode on the numeric indicator 612 by turning the dial 610, then depressing the display button 611 to turn on and light up a specific numeric indicator 602A in the interior of housing 601. FIG. 22B shows the step of filling water 620 inside the housing 601 up to the visual indicator 602A. When the top of the water level 620 reaches the height of the visual indicator light 602A, the sequence proceeds to FIGS. 22C and 22D, where the bottle 650 is placed within the housing 601. The top of the water level 620 displaced upwards when the bottle 650 is placed therein, as shown in FIGS. 22C and 22D. Once the bottle 650 is placed within the housing 601, the display button 611 may be depressed to power the heating cycle and warm up the water 620 to a desired temperature.

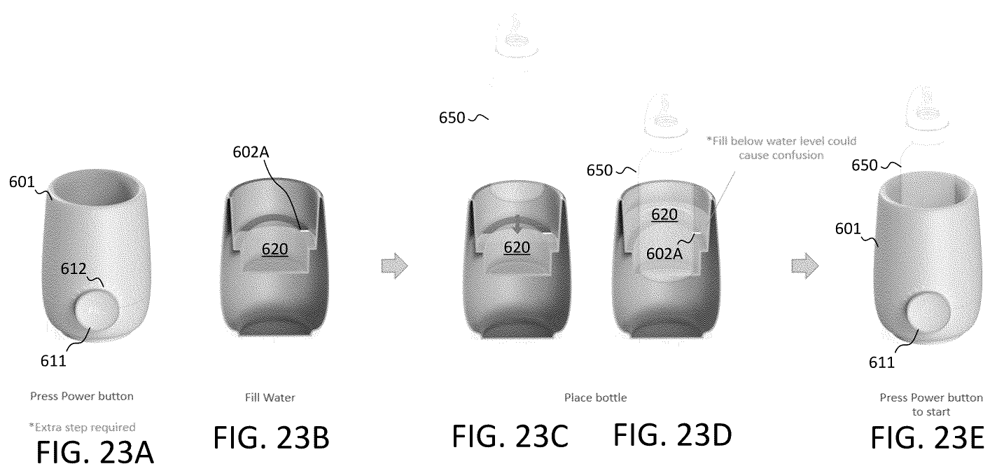

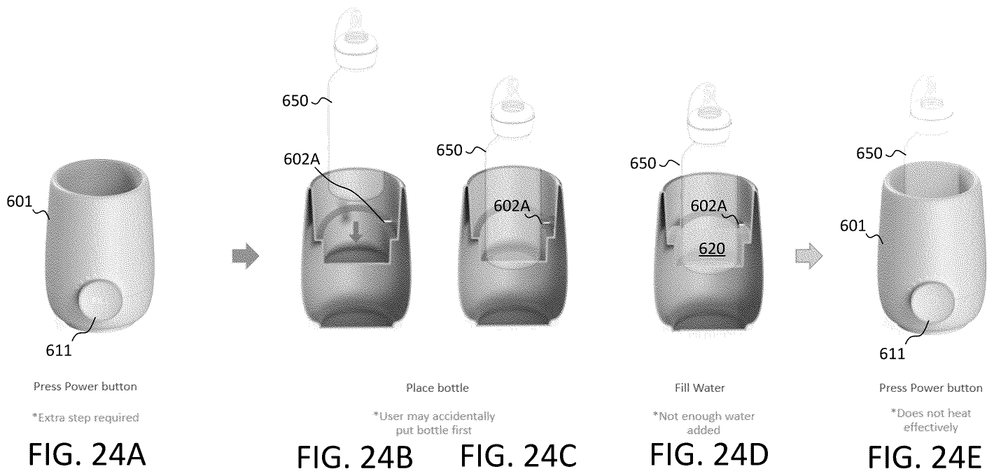

FIGS. 23A-23E show an exemplary sequence of user experience with the bottle warmer 600, but with a first potential problem. The sequence shown in FIGS. 23A-23E is the same as shown in FIGS. 22A-22E, but with the highlighted portion of FIG. 23D. For some users, there may be confusion created by this sequence when after the bottle 650 is placed inside the interior of the housing 601, the water level 620 rises above the visual indicator light 602A. Although the warmer 600 is designed to operate in this manner, the confusion about the rising water 620 above the desired visual indicator light 602A may cause the user to second guess or fill water below the visual indicator light 602A to attempt to match the height of the water 620 once the bottle 650 is placed therein, which is not how this bottle warmer 600 is intended to operate, as illustrated more specifically in FIGS. 24A-24E.

FIGS. 24A-24E show an exemplary sequence of user experience with the bottle warmer 600, but with another potential problem. The sequence shown in FIGS. 24A-24E is the same as shown in FIGS. 22A-22E, but with the highlighted portions of FIG. 24B-D. In some scenarios, the user may accidentally or intentionally place the bottle 650 within the housing 601 before pouring water 620 therein. As shown in FIGS. 24B-24C, once the bottle 650 is placed within the housing 601, water is then poured into the housing 601. The user may believe that the proper water fill line is as indicated by the visual indicator 602A, which is set with by the display button 611. However, once the water 620 level is matched to the visual indicator 602A, there is not enough water to effectively heat up the bottle 350. This is because the water level 620 should have been set first before the introduction of the bottle 650.

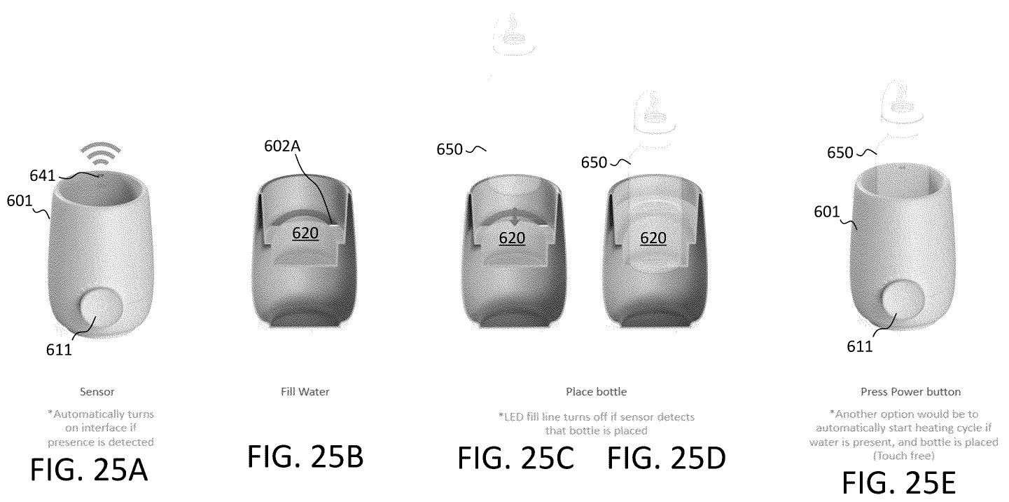

FIGS. 25A-25E provide a solution to the problems set forth in FIGS. 23A-23E and 24A-24E. The sequence shown in FIGS. 25A-25E is the same as shown in FIGS. 22A-22E, but with the differences discussed herein. FIG. 25A shows a smart sensor 641 positioned on an interior wall of housing 601. The smart sensor 641 activates the display 611 if it detects movement in its vicinity, similar to a motion detector. With the smart sensor 641 detecting a user in its proximity who wants to use the warmer 600, the display 611 is turned on, which also relays the desired numeric indicator 612 value to the visual display indicator 602A inside the housing 601. The user is then prompted to fill the housing 601 with water up to the level of the visual indicator light 602A, as shown in FIG. 25B. The bottle 650 is then placed inside the housing 601, the smart sensor 641 detects its presence, and prompts the visual indicator light 602A to turn off, as shown in FIG. 25D. The power button 611 may then be depressed to initiate the heating function. Optionally, once the visual indicator 602A is turned off at the step shown in FIG. 25D, then the warmer 600 may automatically proceed to FIG. 25E and initiate the heating function without further user input. In essence, the smart sensor 641 makes part of the process “touch free” by automating some of the steps. The smart sensor 641 controlled sequence shown in FIGS. 25A-25E addresses or obviates the problem highlighted in the sequence shown in FIGS. 23A-23E, relating to the confusion of the water level 620 in housing 601. This detection of water in the housing 601 may be done through the smart sensor 641 and/or a separate water sensor, weight sensor, visual field sensor or other tool, as appreciated by one having ordinary skill in the art.

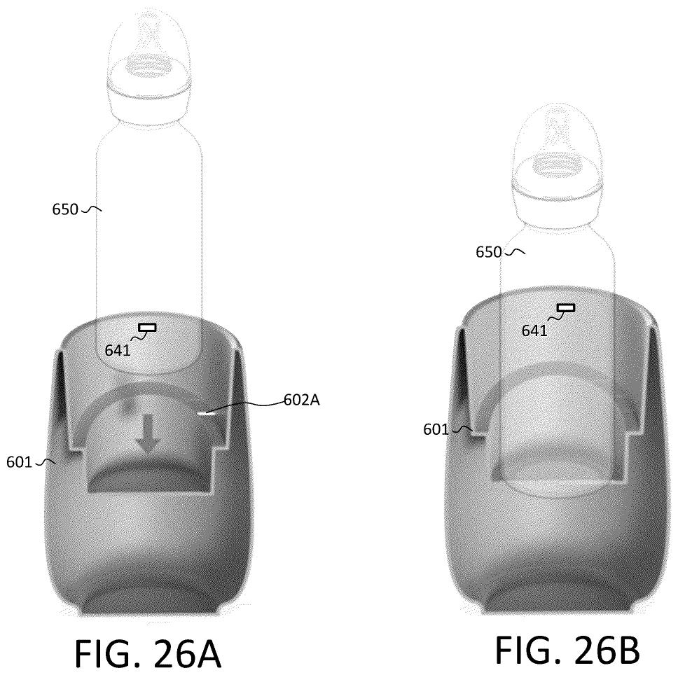

Another benefit of the smart sensor 641 is shown in FIGS. 26A-26B, which addresses the problem shown in the sequence of FIGS. 24A-24E. If bottle 650 is intentionally or accidentally placed first inside the housing 601, as shown in FIG. 26A, then the visual indicator light 602A is turned off, as shown in FIG. 26B, thereby not providing the user any visual feedback as to the proper level of water needed. This should prompt the user to remove the bottle 650 to re-start the process. This would avoid the confusion of the visual indicator light 602A being lower than the bottle level. This feature also directs the user to fill the water first before putting in the bottle 650.

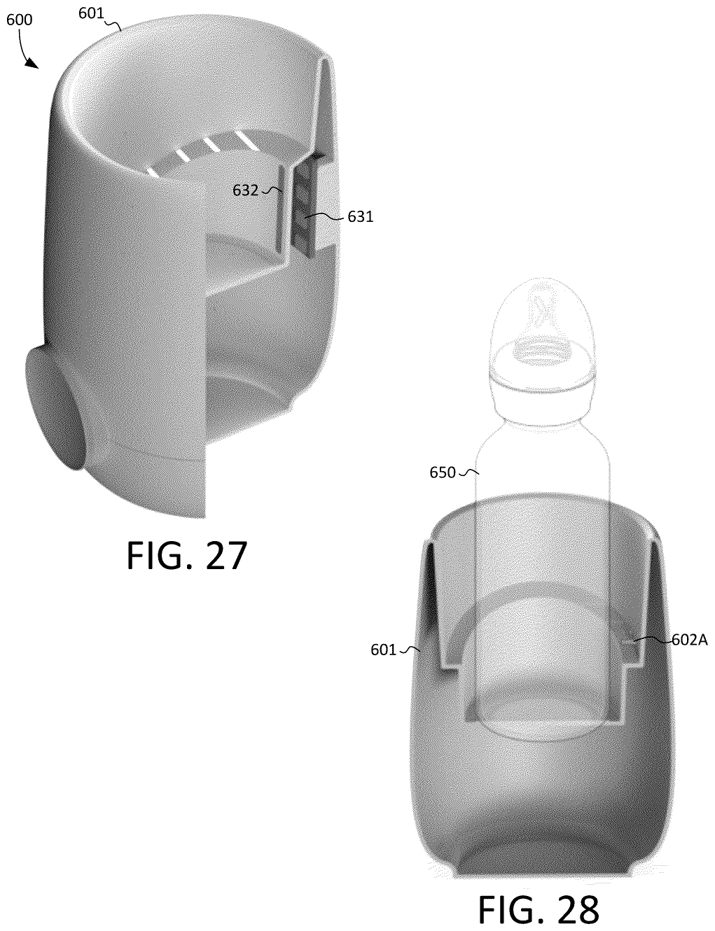

FIG. 27 shows another exemplary embodiment of a bottle warmer 600 with a feature which may be incorporated into any of the other embodiments described in this disclosure. An interior water level sensor 631 determines the proper height of the water that is inside the housing 601. This determination may be through a vertical sensor strip 632 that is on an interior wall of the housing 601. The vertical sensor strip 632 relays the detected water height level to the interior sensor 631 which then uses the information to either pause or progress the sequence of operation shown in the other figures described above. For example, the water level sensor assembly 631/632 incorporated into the sequence shown in FIGS. 25A-25E allows the sequence to proceed from FIG. 25A to 25D if enough water has been poured into the housing 601 and detected by the water level sensor assembly 631/632. Likewise, as shown in FIGS. 26A-26B, the water level sensor assembly 631/632 detects the level of water in the housing shown in FIG. 26A, and if not enough water is detected, it shuts off the sequence when the bottle 650 is inserted, as shown in FIG. 26B.

FIG. 28 shows yet another exemplary embodiment of the bottle warmer 600 with a visual indicator 602A that shows a red (or other color) light indicating an error. For example, if the bottle 650 is placed inside the housing 601 first without water, then the visual indicator 602A will turn red indicating an error, as opposed to the normal indicator color (white or other). This feature also directs the user to fill the housing 601 with water first.

The illustrations and examples provided herein are for explanatory purposes and are not intended to limit the scope of the appended claims. It will be recognized by those skilled in the art that changes, or modifications may be made to the above-described embodiments without departing from the broad inventive concepts of the invention. It is understood therefore that the invention is not limited to the particular embodiments which are described but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed:

1. A device, comprising:
an outer housing;
an inner housing;
visual indicators positioned on a ramp along the inner housing; wherein the visual indicators are visible from an interior portion of the inner housing; and
a sensor positioned on the inner housing, and adapted to turn on one of the visual indicators upon detection of a motion in proximity to the sensor.

2. The device of claim 1, wherein the inner housing includes a tapered top portion, a cylindrical middle portion, and a base.

3. The device of claim 2, wherein the visual indicators are positioned on the cylindrical middle portion.

4. The device of claim 1, wherein one or more of the outer housing and the inner housing is opaque.

5. The device of claim 1, wherein the visual indicators include a vertical stack of light up markings.

6. The device of claim 1, wherein the visual indicators include a horizontal stack of light up markings having two ends.

7. The device of claim 1, wherein the visual indicators include a horizontal stack of concentric continuous light up markings.

8. The device of claim 1, wherein the visual indicators include a horizontal stack of light up markings having faded edges.

9. The device of claim 1, wherein the visual indicators include a horizontal stack of light up markings having uniform colors and defined edges.

10. The device of claim 1, wherein the visual indicators include a horizontal stack of concentric continuous light up markings having uniform colors.

11. The device of claim 1, wherein the visual indicators include a horizontal stack of concentric continuous light up markings having differing colors.

12. The device of claim 1, wherein the visual indicators include a horizontal stack of light up markings with alphanumerical indicators.

13. The device of claim 1, wherein the visual indicators include LED lights.

14. The device of claim 1, further comprising a PCB positioned between the outer housing and the inner housing.

15. A device, comprising:
an outer housing;
an inner housing;
a PCB positioned between the outer housing and the inner housing;
visual indicators including LED lights and positioned on a ramp along the inner housing; wherein the visual indicators are visible from an interior portion of the inner housing;
a first sensor positioned on the inner housing, and adapted to turn on one of the visual indicators upon detection of a motion in proximity to the first sensor; and
a second sensor to determine level of fluid to be heated.

16. The device of claim 15, wherein the inner housing includes a tapered top portion, a cylindrical middle portion, and a base.

17. The device of claim 16, wherein the visual indicators are positioned on the cylindrical middle portion.

18. The device of claim 15, wherein one or more of the outer housing and the inner housing is opaque.

19. A device, comprising:
an outer housing;
an inner housing including a cylindrical middle portion and a base;
a PCB positioned between the outer housing and the inner housing;
visual indicators including LED lights in a series of light up markings, and positioned on a ramp on the cylindrical middle portion of the inner housing; wherein the visual indicators are visible from an interior portion of the inner housing;
a first sensor positioned on the inner housing, and adapted to turn on one of the visual indicators upon detection of a motion in proximity to the sensor; and
a second sensor to determine level of fluid to be heated.

20. The device of claim 19, wherein the markings are illuminated according to the level detected by the sensor.
